(19) United States
(12) Patent Application Publication
(10) Pub. No.: US 2008/0204962 A1
(43) Pub. Date: Aug. 28, 2008

(54) Surge absorber

(76) Inventor: Li-Hua Lin, Hsintien (TW)

Correspondence Address: TROXELL LAW OFFICE PLLC, Suite 1404, 5205 Leesburg Pike, Falls Church, VA, 22041, US

(21) Appl. No.: 11/711,133

(22) Filed: Feb. 27, 2007

(51) Int. Cl. H02H 9/04

(52) U.S. Cl. 361/118

(57) ABSTRACT

A surge absorber comprises a ceramic transistor and several electrical conductors. The ceramic transistor comprises a main body and two electrode layers coated respectively on both lateral surfaces of the main body. The electrical conductors are linearly welded to the outer surface of the ceramic transistor via their respective one ends. In addition, the other ends of the electrical conductors are coupled to a terminal. Besides, the electrical conductors are linearly welded to the outer surface of the ceramic transistor so as to provide the advantages of not being easily damaged and increasing reliability.

### FIELD OF THE INVENTION

The present invention relates to an improved structure of surge absorber, and more particularly to an improved structure of surge absorber that has several electrical conductors linearly welded to the outer surfaces of the ceramic transistor so as to provide the advantages of not being easily damaged and increasing reliability.

### BACKGROUND OF THE INVENTION

The surge absorber has advantages of fast response, unparalleled absorption for transient voltage characteristics, high stabilization for circuit voltage, and symmetrical V-I characteristics curve. Therefore, a surge absorber is usually electrically connected between an electric power and an expensive load machine so as to absorb the surge if the electric current or voltage supplied by the electric power is too large, thereby preventing burn-out of the load machine due to excessive electric current so as to achieve the purposes of protecting the load machine or other expensive devices.

Referring to FIG. 1, an elevational view of a conventional surge absorber is shown. The surge absorber 1 has a ceramic transistor 11, two electrode layers 12 and two flat-type conductors 13. The ceramic transistor 11 has a respective electrode layer 12 on both sides, and the outer surface of the electrode layer 12 is welded to one end of a respective flat-type conductor 13. In addition, its outside is coated with a layer of epoxy resin for insulation and moisture proofing. The surge absorber utilizes a grain boundary phenomenon of the ceramic transistor 11 to protect against the transient over-voltage for eliminating the surge energy in the form of heat. During its work, the electric current must be guided to pass through the main body of the ceramic transistor 11 so as to eliminate the surge energy in the form of heat.

However, during its practical use, the conventional surge absorber has the following drawbacks: (1) The flat-type conductor has a certain volume that causes a certain degree of internal stress, so when the flat-type conductor is welded to the outer surface of the electrode layer, the internal stress and the large electrical current may cause the internal portion of the surge absorber to be damaged easily; and (2) The flat-type conductor is generally made of copper material with good electric conductivity so when the large electric current causes the flat-type conductor and the ceramic transistor to generate high temperature, the ceramic transistor may be thus broken and damaged by expansion of the flat-type conductor, which has higher expansion factor than the ceramic transistor.

Accordingly, there is a need to disclose a surge absorber that is not easy to be damaged and is able to increase reliability to overcome the conventional drawbacks.

### SUMMARY OF THE INVENTION

In view of the above-mentioned conventional drawbacks, a major object of the present invention is to provide an improved structure of surge absorber that is not easy to be damaged and is able to increase reliability.

In order to achieve the above-mentioned and other objects, the present invention discloses a surge absorber comprises a ceramic transistor and several electrical conductors.

The ceramic transistor comprises a main body and two electrode layers coated respectively on both lateral surfaces of the main body.

The electrical conductors are linearly welded to the outer surface of the ceramic transistor via their respective one ends. In addition, the other ends of the electrical conductors are coupled to a terminal.

### BRIEF DESCRIPTION OF THE DRAWINGS

FIG. 1 is an elevational diagram showing a conventional surge absorber.

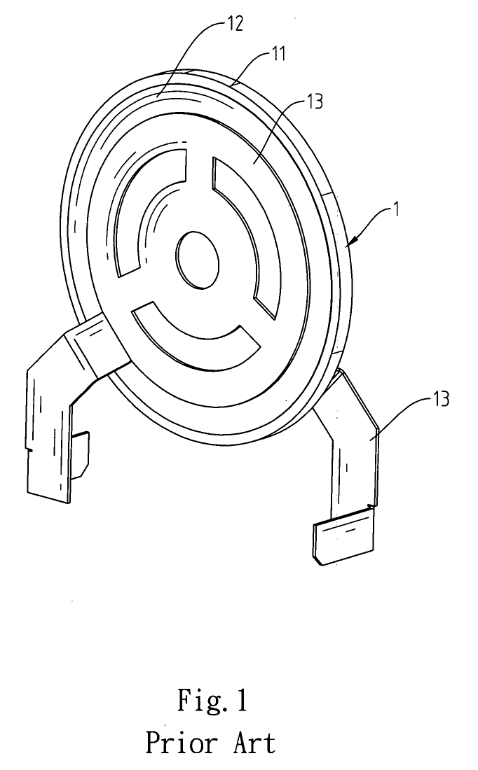

FIG. 2 is a planar diagram of the present invention;

FIG. 3 is a schematic view showing the motion of welding the electrical conductors to the electrode layers of the main body of the present invention.

FIG. 4 is a schematic view showing another electrical conductor welded to the electrode layer of the main body of the present invention.

FIG. 5 is a cross-sectional view showing that the surge absorber of the present invention is coated with the epoxy resin layer and covered with the outer shell.

### DETAILED DESCRIPTION OF THE PREFERRED EMBODIMENT

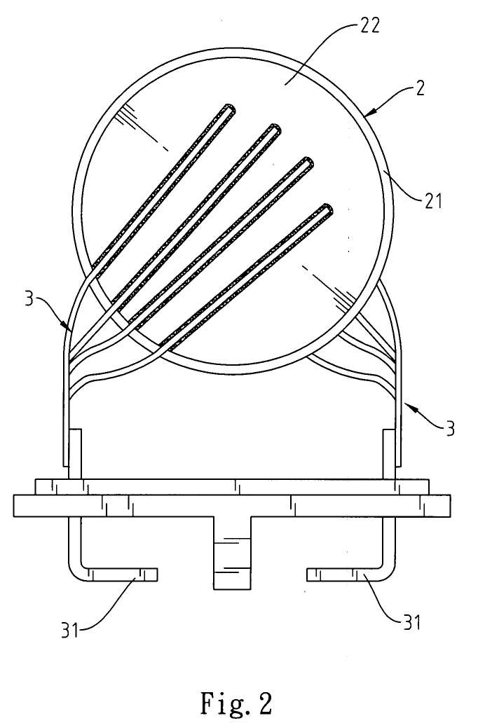

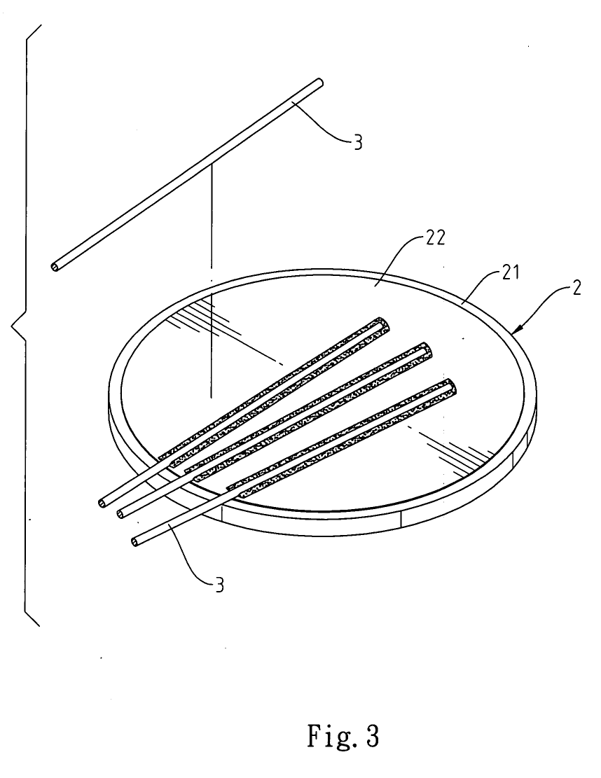

Referring to FIGS. 2 and 3, an improved structure of surge absorber of the present invention comprises a ceramic transistor 2 and several electrical conductors 3.

The ceramic transistor 2 comprises a main body 21 and two electrode layers 22 coated respectively on both lateral surfaces of the main body 21. The main body 21 is designed for providing a breakdown path for the surge absorber.

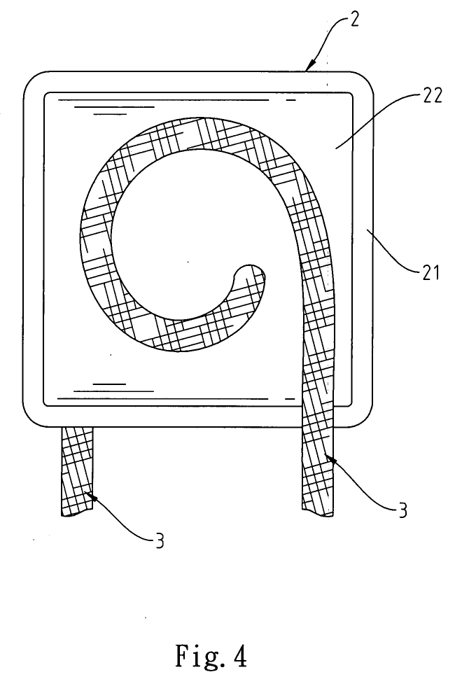

The electrical conductors 3 are linearly welded to the outer surfaces of the electrode layers 22 of the ceramic transistor 2 via their respective one ends. In addition, the respective other ends of the electrical conductors 3 are coupled to a terminal 31. Besides, the electrical conductors 3 are woven conducting wires (shown in FIG. 4) or general copper wires (shown in FIG. 3).

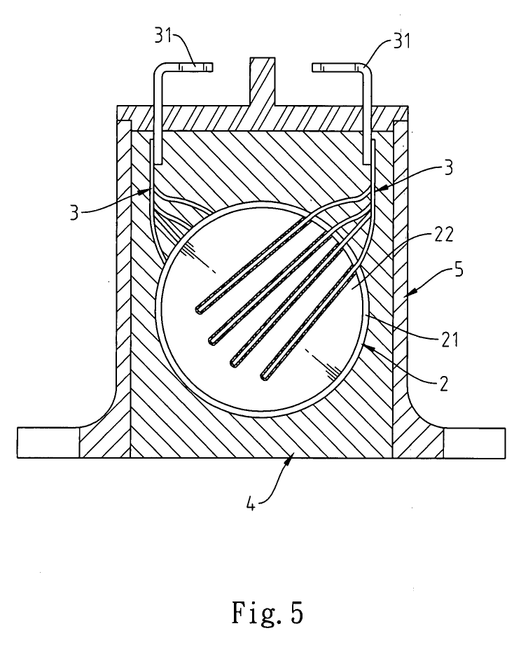

The assembled structure of the forgoing components is shown in FIG. 5. The improved structure of surge absorber of the present invention has coated thereon a layer of epoxy resin 4. In addition, the outside of the surge absorber is covered with an outer shell 5. Referring further to FIG. 5, the terminal 31 that couples to the electrical conductors 3 is electrically connected to a wiring or a machine to be protected (not shown). If an abnormal voltage occurs in this wiring or machine (not shown), the surge absorber allows the electric current to pass through the electrode layers 22 for generating the heat to eliminate the surge energy, thereby protecting the wiring and the machine.

It is worth to further mention that the respective one ends of the electrical condors 3 are linearly welded to the outer surfaces of the electrode layers 22, and the respective one ends of the electrical condors 3 may be spirally welded to the outer surfaces of the electrode layers 22 (shown in FIG. 4) or linearly, radially welded to the outer surfaces of the electrode layers 22 (shown in FIG. 2) to achieve the same purposes and effects as the foregoing preferred embodiment, wherein the redundant description thereof is omitted.

1. A surge absorber, comprising:
a ceramic transistor having a first and second outer surface; and
a first pluraIity of electrical conductors linearly, radially welded to the first outer surface of said ceramic transistor and a second plurality of electrical conductors welded to the second outer surface.

2. The surge absorber according to claim 1, wherein said electrical conductors are copper wires.

3. The surge absorber according to claim 1, wherein said electrical conductors are woven conducting wires.

4. (canceled)

5. A surge absorber according to claim 1, wherein both said first and second electrical conductors are linearly, radially welded to the first and second outer surfaces of said ceramic transistor.

6. The surge absorber according to claim 1, wherein a first relative spacing between the first electrical conductors is substantially equal to a second relative spacing between the second electrical conductors.

7. A surge absorber, comprising:
a ceramic transistor having a first and second outer surface; and
a first plurality of electrical conductors welded to the first outer surface of said ceramic transistor and a second plurality of electrical conductors welded to the second outer surface,
wherein said first electrical conductors are curved to be spirally welded to the first outer surface of said ceramic transistor and the second electrical conductors are curved to be spirally welded to the second outer surface of said ceramic transistor.
